(19) United States
(12) Patent Application Publication
(10) Pub. No.: US 2020/0104824 A1
(43) Pub. Date: Apr. 2, 2020

(54) USING AN IMAGE AS A ONE-TIME PASSWORD FOR AUTHENTICATION DURING A POINT-OF-SALE TRANSACTION

(71) Applicant: CA, Inc., New York, NY (US)

(72) Inventors: Lyju Vadassery, Mumbai (IN); Vijay Shashikant Kulkarni, Bangalore (IN); Vikrant Nandakumar, Bangalore (IN); Meera Viswanathan, Chennai (IN)

(73) Assignee: CA, Inc., New York, NY (US)

(21) Appl. No.: 16/144,543

(22) Filed: Sep. 27, 2018

(51) Int. Cl. G06Q 20/32; G06Q 20/20; H04L 29/06; G06K 9/46

(52) U.S. Cl. CPC G06Q 20/3274; G06K 9/4671; H04L 63/0838; G06Q 20/206

(57) ABSTRACT

A system can include a database, a communication interface, a processing circuit, and a memory. The processing circuit can receive a request from a remote user device to set an authentication password for a transaction and receive first encrypted keypoints associated with a first image of a portable object. The processing circuit can decrypt the first encrypted keypoints to generate first keypoints and store the first keypoints as the authentication password. The processing circuit can receive an authentication request from the remote user device to use the authentication password to authenticate the user of the remote device to complete the transaction. The processing circuit can receive second encrypted keypoints associated with a second image of the portable object and can decrypt the second encrypted keypoints to generate second keypoints. The processing circuit can determine whether the second keypoints match the first keypoints and can transmit authorization of the transaction.

### TECHNICAL FIELD

The present disclosure relates to computing systems, and, in particular, to a computer system for using an image as a one-time password for authentication during a point-of-sale transaction.

### BACKGROUND

A point-of-sale (“POS”) transaction can occur when a customer tenders payment in exchange for goods or services. The payment may be tendered via an electronic transfer of funds (e.g., using a credit card or an e-check). During some POS transactions, a customer may be asked for authentication or proof of identity by a merchant or a payment facilitator (e.g., a bank) from which the funds are being transferred. A rise in malicious activity (e.g., identity theft) has led to advances in authentication technology and authentication can require more than providing a picture identification (e.g., a driver's license) to the merchant. For example, authentication can include providing biometrics (e.g., fingerprints) or other two-factor authentication. But, biometrics and other authentication relating to physical attributes of a customer can be faked by malicious individuals. Accordingly, authentication can either be time consuming and lead to a dampening effect on transactions to or authentication can be weak and lead to malicious activity.

### SUMMARY

Some embodiments disclosed herein are directed to a system. The system can include a database, a communication interface, a processing circuit, and a memory. The memory can have instructions stored therein that are executable by the processing circuit for causing the processing circuit to receive, via the communication interface, a request from a remote user device to set an authentication password for a transaction associated with a user of the remote user device. The request can be received prior to the transaction. The processing circuit can receive, via the communication interface and prior to the transaction, first encrypted keypoints associated with a first image of a portable object. The processing circuit can decrypt the first encrypted keypoints to generate first keypoints. The processing circuit can store, in the database, the first keypoints as the authentication password and as associated with an identifier for the user. The processing circuit can receive, via the communication interface, an authentication request from the remote user device to use the authentication password to authenticate the user of the remote device to complete the transaction. Responsive to receiving the authentication request from the remote user device, the processing circuit can receive, via the communication interface, second encrypted keypoints associated with a second image of the portable object. The processing circuit can decrypt the second encrypted keypoints to generate second keypoints. The processing circuit can determine whether the second keypoints match the first keypoints. Responsive to determining that the second keypoints match the first keypoints, the processing circuit can transmit, via the communication interface, authorization of the transaction.

Some embodiments disclosed herein are directed to a method. The method can include receiving, via a communication interface, a request from a remote user device to form an authentication password for a transaction associated with a user of the remote user device. The request can be received prior to the transaction. The method can further include obtaining, prior to the transaction, first keypoints comprising an electronic identification a first image of a portable object captured by the remote user device. The method can further include storing, in a database, the first keypoints as the authentication password and as associated with an identifier for the user. The method can further include receiving, via the communication interface, an authentication request from the remote user device to use the authentication password to authenticate the user of the remote device to complete the transaction. The method can further include responsive to receiving the authentication request from the remote user device, obtaining second keypoints comprising an electronic identification a second image of the portable object captured by the remote user device. The method can further include determining whether the second keypoints match the first keypoints. The method can further include responsive to determining that the second keypoints match the first keypoints, transmitting, via the communication interface, authorization of the transaction.

Some embodiments disclosed herein are related to a computer program product. The computer program product can include non-transitory computer readable medium storing program code configured to be executed by a processing circuit to perform operations. The operations include receiving, via a user interface of a user device, a request to set an authentication password for a transaction at a remote location prior to the transaction. The operations further include, responsive to receiving the request to set the authentication password for the future transaction at the remote location, capturing, via a camera, a first image of a portable object. The operations further include generating first keypoints from the first image. The first keypoints can include an electronic identification of the first image. The operations further include encrypting the first keypoints to form first encrypted keypoints. The operations further include transmitting, via a communication interface, the first encrypted keypoints to a remote authentication server. The operations further include receiving, via the communication interface, a request to complete the transaction. The operations further include, responsive to receiving the request to complete the transaction, capturing, via the camera, a second image of the portable object. The operations further include generating second keypoints from the second image. The operations further include encrypting the second keypoints to form second encrypted keypoints. The operations further include transmitting, via the communication interface, the second encrypted keypoints to the remote authentication server. The operations further include receiving, via the communication interface, confirmation that the second keypoints matched the first keypoints and that the transaction has been authorized by the remote authentication server.

Corresponding operations by computer program products and electronic devices are disclosed. Other methods, computer program products, and electronic devices according to embodiments will be or become apparent to one with skill in the art upon review of the following drawings and detailed description. It is intended that all such additional methods, computer program products, and electronic devices be included within this description, be within the scope of the present inventive subject matter, and be protected by the accompanying claims. Moreover, it is intended that all embodiments disclosed herein can be implemented separately or combined in any way and/or combination.

### BRIEF DESCRIPTION OF THE DRAWINGS

Aspects of the present disclosure are illustrated by way of example and are not limited by the accompanying drawings. In the drawings:

FIG. 1 is a block diagram of an example of a system for using an image as a one-time password for authentication during a point-of-sale transaction in accordance with some embodiments of the present disclosure;

FIG. 2 is a block diagram of an example of a user device for capturing and transmitting an image for use as a one-time password to an authentication server in accordance with some embodiments of the present disclosure;

FIG. 3 is a block diagram of an example of an authentication server for using an image as a one-time password for authentication during a point-of-sale transaction in accordance with some embodiments of the present disclosure;

FIG. 4 is a block diagram of an example of a payment processor for processing payment during a transaction in accordance with some embodiments of the present disclosure;

FIG. 5 is a flow chart of an example of a process for using an image as a one-time password for authentication during a point-of-sale transaction in accordance with some embodiments of the present disclosure;

FIG. 6 is a flow chart of an example of another process for using an image as a one-time password for authentication during a point-of-sale transaction in accordance with some embodiments of the present disclosure;

FIG. 7 is a flow chart of an example of a process for capturing and transmitting an image for use as a one-time password to an authentication server in accordance with some embodiments of the present disclosure; and

FIG. 8 is a flow chart of an example of another process for capturing and transmitting an image for use as a one-time password to an authentication server in accordance with some embodiments of the present disclosure.

### DETAILED DESCRIPTION

In the following detailed description, numerous specific details are set forth in order to provide a thorough understanding of embodiments of the present disclosure. However, it will be understood by those skilled in the art that the present invention may be practiced without these specific details. In other instances, well-known methods, procedures, components, and circuits have not been described in detail so as not to obscure the present invention. It is intended that all embodiments disclosed herein can be implemented separately or combined in any way and/or combination.

As explained above, authentication of a user can be performed as part of a transaction, but efficient and secure authentication can be difficult. Various embodiments of the present disclosure are directed to providing more efficient and secure authentication of a user during a transaction by using an image as a one-time password (“OTP”) for authentication during point-of-sale transactions. In some embodiments, an image of a portable object can be captured by a user device associated with a user prior to a transaction. The user device can generate keypoints from the image using a scale-invariant feature transformation (“SIFT”) algorithm. The keypoints can be stored in a database as associated with the user. During the transaction, a second image of the portable object can be captured by a user device associated with the user. The user device can generate second keypoints from the second image using the SIFT algorithm and the second keypoints can be compared to the first keypoints in order to authenticate the user.

In some embodiments, the portable object can include any suitable object that can be photographed a user device prior to the transaction and during the transaction. For example, the portable object can include a watch, shoe, purse, or car associated with the user. The keypoints generated from the image can be based on the portable object and the positioning of the portable object. For example, the watch being on the wrist of the user or the purse being on the shoulder of the user. Since the portable object is not solely tied to a physical attribute or biometric of the user and can encompass a broad range of objects, using an image of the portable object as a one-time password for authentication can provide an efficient and secure authentication process.

In additional or alternative embodiments, further limitations can be applied to the transaction prior to the transaction being performed. For example, the user device can receive input from the user indicating a location associated with the transaction or a time frame associated with the transaction prior to the transaction. Authentication may be limited to transactions occurring within a threshold distance of the location and within a threshold time of the time frame.

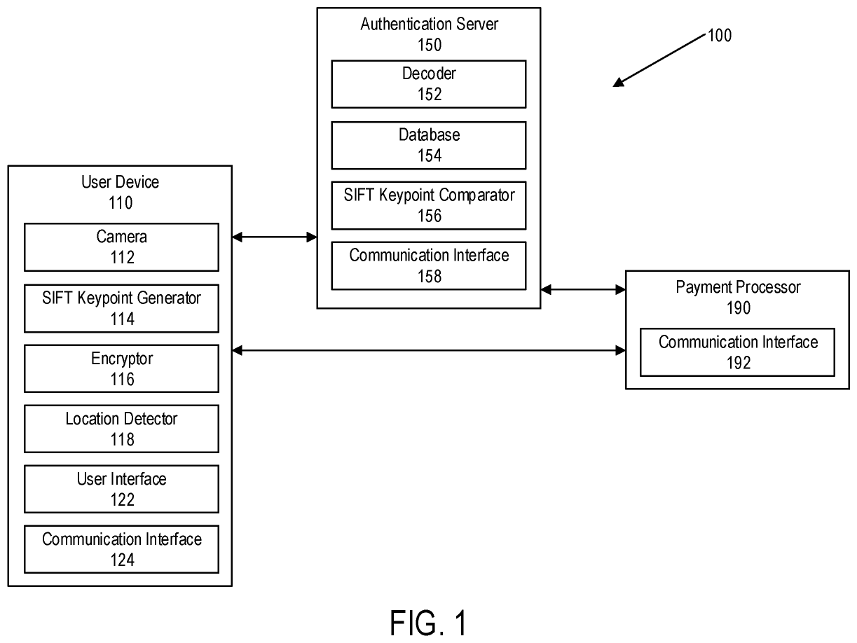

FIG. 1 depicts an example of a system 100 for using an image as a one-time password for authentication during a point-of-sale transaction in accordance with some embodiments of the present disclosure. In this example, system 100 includes a user device 110, an authentication server 150, and a payment processor 190.

The user device 110 includes a camera 112, SIFT keypoint generator 114, encryptor 116, location detector 118, user interface 122, and a communication interface 124.

The user interface 122 can allow the user device 110 to receive indication from a user associated with the user device 110 that the user plans to initiate a transaction. The camera 112 can be used to capture an image of a portable device. The portable device can be any suitable object that the user can capture a picture of prior to the transaction and during the transaction. For example, the portable device can be a wearable device (e.g., a watch, glasses, shirt, shoes, belt) or another device (e.g., a briefcase, a friend, or a car). In some embodiments, the user device 110 can reject images that are not taken contemporaneously taken (e.g., taken live) by detecting whether the image was captured via camera 112 or uploaded from another location.

The SIFT keypoint generator 114 can generate keypoints based on the image using a SIFT algorithm. The keypoints can be electronic identifications of the image that can uniquely identify the image while being smaller than the image (e.g., requiring less space to store). The encryptor 116 can be any suitable encryption device for encrypting the keypoints to generate encrypted keypoints. The encryptor can be provided a key and an encryption technique by the authentication server 150.

The user device 110 can generate first encrypted keypoints based on a first image of a portable object prior to a transaction and transmit the first encrypted keypoints to the authentication server 150 via communication interface 124. The first encrypted keypoints can be used by the authentication server 150 to create an authentication password associated with the transaction.

The user device 110 can subsequently generate second encrypted keypoints based on a second image of the portable object during the transaction and transmit the second encrypted keypoints to the authentication server 150 via communication interface 124. The second encrypted keypoints can be used by the authentication server 150 to authenticate the user.

The location detector 118 can detect a current location, which can be transmitted to the authentication server 150, via communication interface 124, during the transaction as part of the authentication process.

The authentication server 150 includes a decoder 152, a database 154, SIFT keypoint comparator 156, and a communication interface 158.

The communication interface 158 can be communicatively coupled to the user device 110 and the payment processor 190. In some embodiments, the authentication server 150 receives first encrypted keypoints from the user device 110, via communication interface 158 prior to a transaction. The decoder 152 can decrypt the first encrypted keypoints to determine first keypoints associated with an image of a portable object. The database 154 can store the first keypoints as associated with a specific user account.

In additional or alternative embodiments, the authentication server 150 receives second encrypted keypoints from the user device 110, via communication interface 158 during a transaction. The decoder 152 can decrypt the second encrypted keypoints to determine second keypoints associated with a second image of a portable object. The SIFT keypoint comparator 156 can compare the second keypoints with the first keypoints. In response to determining the second keypoints match the first keypoints, the authentication server 150 can authorize the transaction by transmitting. via the communication interface 158, authorization of the transaction to the user device 110 or the payment processor 190.

The payment processor 190 includes a communication interface 192. In this example, communication interface 192 communicatively couples the payment processor 190 to both the authentication server 150 and the user device 110.

In some embodiments, the payment processor 190 can receive a request to transfer funds as part of a transaction. In some examples, the request can be received from the user device 110 or a device associated with a merchant in the transaction. In response to receiving the request, the payment processor 190 can request authentication of the user and authorization of the transaction from the authentication server 150. In additional or alternative examples, the request can be received directly from the authentication server 150 and include authorization to transfer the funds.

In some embodiments, the payment processor 190 can be associated with a bank and can transfer funds from an account associated with the user to an account associated with a merchant in response to receiving authorization of the transaction. In some examples, the authorization of the transaction can be received directly from the authentication server 150. In additional or alternative examples, the authorization of the transaction can be received from the user device 110 and include a certification generated by the authentication server 150.

Although FIG. 1 depicts a system for using an image as a one-time password for authentication during a point-of-sale transaction in accordance in which the authentication server 150 and the payment processor 190 are physically separate and independent devices, other implementations are possible. For example, authentication server 150 can be included within a payment processor such that the payment processor authenticates the user and transfers payment during a transaction. Although the embodiments herein generally describe using an image as a one-time password, in some embodiments, the image can be used multiple times.

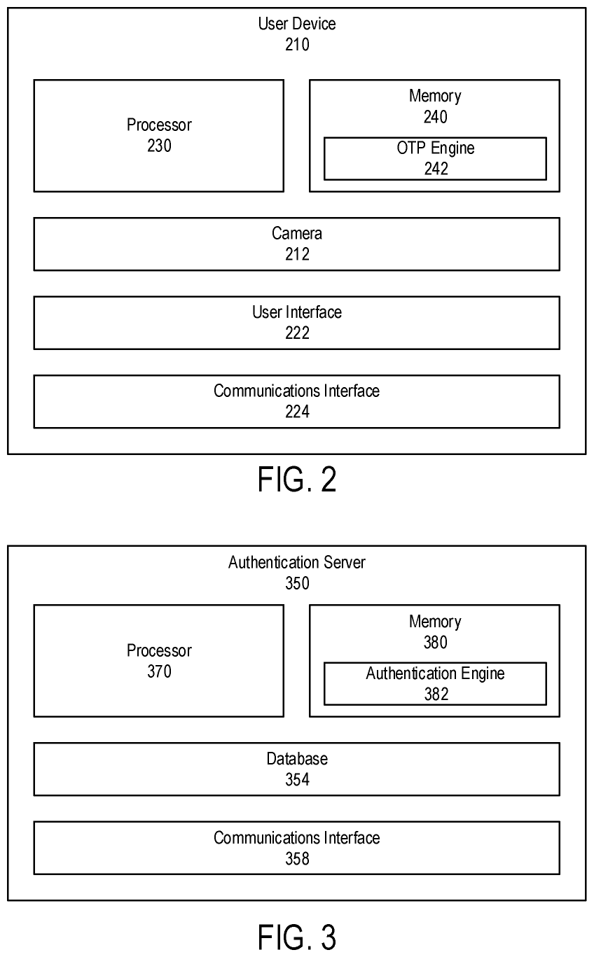

FIG. 2 depicts an example of a user device 210 for capturing and transmitting an image for use as a one-time password to an authentication server in accordance with some embodiments of the present disclosure. In this example, preparing device 210 includes a processor 230, memory 240, camera 212, user interface 222, and communication interface 224.

The processor 230 may include one or more data processing circuits, such as a general purpose and/or special purpose processor (e.g., microprocessor and/or digital signal processor) that may be collocated within the user device 210 or distributed across one or more networks. The processor 230 is configured to execute computer program code, for example OTP engine 242, in the memory 240, described below as non-transitory computer readable medium, to perform at least some of the operations described herein as being performed by the user device 210 or any component thereof.

The communication interface 224 may be a wired network interface transceiver, e.g., Ethernet, and/or a wireless radio frequency transceiver that is configured to operate according to one or more communication protocols, e.g., WiFi, Bluetooth, cellular, LTE, etc.

The camera 212 can include any suitable image capture device for capturing an image of a portable object. The portable object can be any object that a user can photograph at a remote location and again during a point-of-sale transaction. For example, the portable object can be a watch on a wrist of the user, shoes on feet of the user, glasses in a pocket of the user, or a purse on the shoulder of a user. In some embodiments, the camera 212 can include a video recorder for capturing a video of a mouth of a user associated with the user device 210 mouthing a passphrase. The video or information associated with the video can be used for stepped-up authentication.

The user interface 222 may be a display device, a touch input interface on a display device, a keyboard, etc. In some embodiments, the user interface 222 can allow the user associated with the user device 210 to set location limitations or time frames associated with the transaction. For example, the user interface 222 can display a map that the user can virtually draw a boundary on to indicate a location in which a transaction is expected to occur. In additional or alternative embodiments, the user interface 222 can allow the user to request an authentication password be set prior to a transaction or request authentication be performed during a transaction.

In some embodiments, user device 210 is an example of the user device 110 in FIG. 1. Although the user device 210 is generally described herein as a single user device, the user device 210 can include multiple user devices associated with the user. For example, the user device 210 can include a computer device with a camera for capturing the first image prior to the transaction and a mobile device with a camera for capturing the second image during the transaction.

FIG. 3 depicts an example of an authentication server 350 for using an image as a one-time password for authentication during a point-of-sale transaction in accordance with some embodiments of the present disclosure. In this example, the authentication server 350 includes a processor 370, memory 380, database 354, and communication interface 358.

The processor 370 may include one or more data processing circuits, such as a general purpose and/or special purpose processor (e.g., microprocessor and/or digital signal processor) that may be collocated within the authentication server 350 or distributed across one or more networks. The processor 370 is configured to execute computer program code, for example authentication engine 382, in the memory 380, described below as non-transitory computer readable medium, to perform at least some of the operations described herein as being performed by the authentication server 350 or any component thereof.

The communication interface 358 may be a wired network interface transceiver, e.g., Ethernet, and/or a wireless radio frequency transceiver that is configured to operate according to one or more communication protocols, e.g., WiFi, Bluetooth, cellular, LTE, etc.

The database 354 can include any suitable non-transitory computer readable medium. Information can be stored in the database associated with user accounts. In some embodiments, the database 354 can store keypoints or images associated with a user account and videos, locations, and time frames can be stored as associated with specific keypoints or images.

The authorization server can be an example of the translating device 160 in FIG. 1. In additional or alternative embodiments, the processor 370 can be spread across a network of devices including a user device and a payment processor.

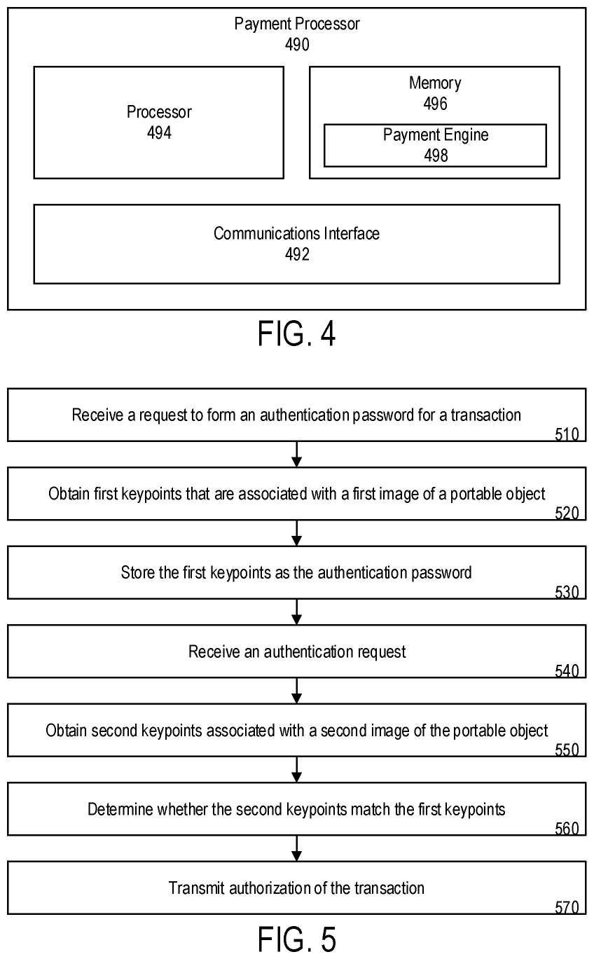

FIG. 4 depicts an example of a payment processor for processing payment during a transaction in accordance with some embodiments of the present disclosure. In this example, payment processor 490 includes a processor 494, memory 496, and communication interface 492.

The processor 494 may include one or more data processing circuits, such as a general purpose and/or special purpose processor (e.g., microprocessor and/or digital signal processor) that may be collocated within the payment processor 490 or distributed across one or more networks. The processor 494 is configured to execute computer program code, for example payment engine 498 in the memory 496, described below as non-transitory computer readable medium, to perform at least some of the operations described herein as being performed by the payment processor 490 or any component thereof.

The communication interface 492 may be a wired network interface transceiver, e.g., Ethernet, and/or a wireless radio frequency transceiver that is configured to operate according to one or more communication protocols, e.g., WiFi, Bluetooth, cellular, LTE, etc.

In some embodiments, payment processor 490 may be an example of payment processor 190 in FIG. 1. In additional or alternative embodiments, payment processor 490 may be included in an authentication server or include an authentication server for authentication a user and authorizing a transaction.

FIG. 5 depicts an example of a process for using an image as a one-time password for authentication during a point-of-sale transaction in accordance with some embodiments of the present disclosure. The process in FIG. 5 is described below in reference to authentication server 350 in FIG. 3, but other implementations are possible.

In block 510, processor 370 receives, via communication interface 358, a request to form an authentication password for a transaction. The request can be received from a remote device and the transaction can be associated with a user of the remote device. For example, the request may be received from an application running on a mobile device associated with the user. The request may be received prior to the transaction, for example, the request may be received from the remote device being used by the user prior to a shopping trip. In additional or alternative embodiments, the request may be received via a website accessed by a computer associated with the user.

In some embodiments, the authentication server 350 may request additional authentication of the user associated with the request. For example, the authentication server 350 may require the user to provide biometric identifiers or answer security questions to verify the user associated with the request is also the same as a user associated with a user account known by the authentication server. The user account can include personal information and payment information used for completing transactions.

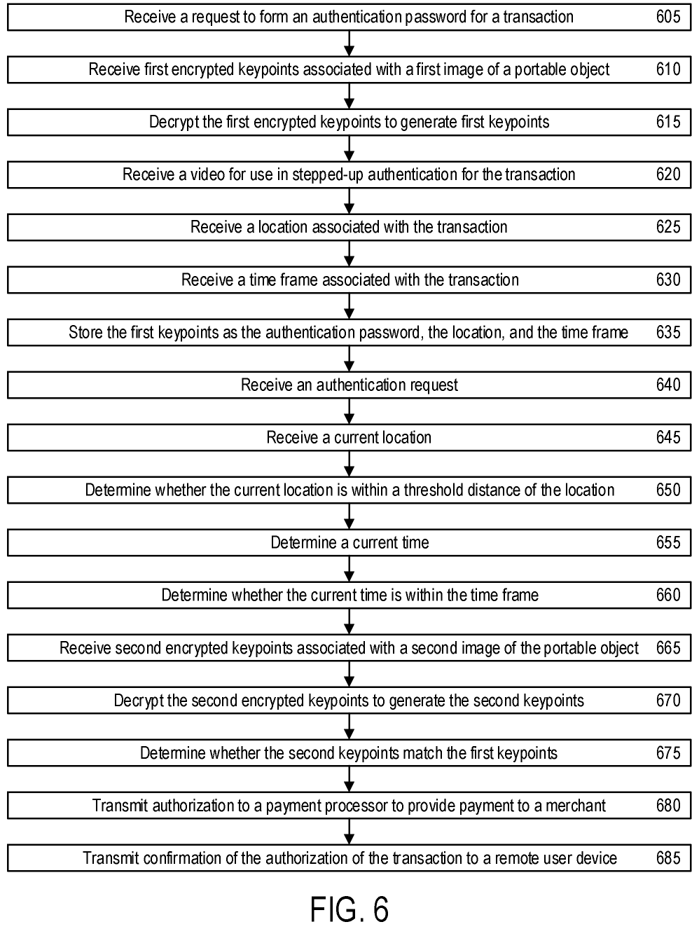

In block 520, processor 370 obtains first keypoints that are associated with a first image of a portable object. In some embodiments, authentication server 350 receives, via communication interface 358, the first image from the remote device associated with the user. The processor 370 can generate the first keypoints from the first image using a SIFT algorithm. As described below, block 610 and block 615 of FIG. 6 depict an additional or alternative embodiment for obtaining the first keypoints based on receiving first encrypted keypoints from a remote device associated with the user.

In block 530, processor 370 stores, in database 354, the first keypoints as the authentication password. In some embodiments, the first keypoints can be stored in the database 354 as associated with an identifier for the user (e.g., a user account).

In additional or alternative embodiments, processor 370 may verify that the keypoints are distinct from any keypoints associated with the identifier for the user that are currently stored in the database 354. Verifying the keypoints are distinct from any keypoints currently stored in the database 354 can prevent a user from reusing an image recently used for another transaction. In some examples, the processor 354 can reject the first keypoints based on finding keypoints having a threshold level of similarity in the database 354. Rejecting the first keypoints can include transmitting, via the communication interface 358, a message requesting new keypoints before setting an authentication password for the user.

In additional or alternative embodiments, processor 370 may verify that the keypoints are distinct from any keypoints currently stored in the database 354. Verifying the keypoints are distinct from any keypoints currently stored in the database 354 can prevent a user from using a stock photograph or a photograph that lacks uniqueness. The database 354 may keep keypoints for a predetermined amount of time (e.g., 90 days) such that an image can be reused after the predetermined amount of time.

In block 540, processor 370 receives, via communication interface 358, an authentication request. In some embodiments, the authentication request provides the authentication server with information regarding a transaction being attempted by a customer. The authentication request can request that the authentication server authenticate that the customer is the user and that transaction being attempted is a transaction desired by the user such that the transaction can be completed.

In some embodiments, the authentication request is received directly from a remote device associated with the user. The remote device may be the same user device that transmitted the request to set the authentication password for the transaction or another remote device associated with the user. In additional or alternative embodiments, the authentication request is received from a payment processor (e.g., payment processor 490 in FIG. 4) in response to the user requesting the payment processor transfer payment to a merchant.

In block 550, processor 370 obtains second keypoints associated with a second image of the portable object. Similarly to the operations in block 520, in some embodiments, the authentication server 350 can receive, via communication interface 358, the second image from the remote device associated with the user. The processor 370 can generate the second keypoints from the second image using a SIFT algorithm. As described below, block 665 and block 670 of FIG. 6 depict an additional or alternative embodiment for obtaining the second keypoints based on receiving second encrypted keypoints from a remote device associated with the user.

In block 560, processor 370 determines whether the second keypoints match the first keypoints. In some embodiments, processor 370 retrieves the first keypoints from the database 354 based on information in the authentication request about the transaction or based on information associated with the user. The processor 370 can compare the first keypoints and the second keypoints using techniques associated with the SIFT algorithm. In response to finding the second keypoints are more than a threshold level different from the first keypoints, the processor 370 can notify a remote device associated with the user that the second image has failed to authenticate the user and that the transaction has not been authorized. In some examples, the authentication server 350 may allow additional keypoints to be obtained based on an additional image of the portable device. In additional or alternative examples, the authentication server 350 may require stepped-up authentication in order to authorize the transaction.

In response to finding the second keypoints are within a threshold level of similarity to the first keypoints, the processor 370 can, in block 570, transmit, via communication interface 358, authorization of the transaction. In some embodiments, processor 370 transmits, via communication interface 358, authorization of the transaction to the payment processor 490 in order to allow funds to be transferred to a merchant associated with the transaction and the transaction to be completed. In additional or alternative embodiments, processor 370 transmits, via communication interface 358, authorization of the transaction directly to a device associated with the merchant or to the remote device associated with the user. In additional or alternative embodiments, the authentication server is included in the payment processor and the processor 370 completes the transaction by transferring funds from an account associated with the user to an account associated with the merchant.

FIG. 6 depicts an example of another process for using an image as a one-time password for authentication during a point-of-sale transaction in accordance with some embodiments of the present disclosure. The process in FIG. 6 is described below in reference to authentication server 350 in FIG. 3, but other implementations are possible.

In block 605, processor 370 receives, via communication interface 358, a request to form an authentication password for a transaction. This operation can be similar to the operations performed in block 510 of FIG. 5. In some embodiments, the request to form the authentication password for the transaction can include additional information, for example, indication that additional parameters (e.g., a location and a time frame) will be set on the transaction.

In block 610, processor 370 receives, via communication interface 358, first encrypted keypoints associated with a first image of a portable object. In block 615, processor 370 decrypts the first encrypted keypoints to generate first keypoints. The first encrypted keypoints may be encrypted to prevent malicious entities from intercepting and copying the first keypoints. In some embodiments, the authentication server 350 assigns a key and an encryption technique to a user account associated with the user and the first keypoints were encrypted using the key and the encryption technique. The processor 370 can use the assigned key to decrypt the first encrypted keypoints.

In block 620, processor 370 receives, via communication interface 358, a video for use in stepped-up authentication for the transaction. In some embodiments, the video is a digital video of the user of the remote user device mouthing a passphrase. In additional or alternative embodiments, the processor 370 receives via the communication interface 358 information associated with the digital video indicating the passphrase or a lip movement pattern of the user when mouthing the passphrase.

In block 625, processor 370 receives, via communication interface 358, a location associated with the transaction. The location associated with the transaction can be received from a remote device associated with the user prior to the transaction. In some embodiments, the location associated with the transaction can be a large area such as a country or city. In additional or alternative embodiments, the location associated with the transaction can be one or more specific retail locations. In some examples, the more precise the location associated with the transaction the lower other requirements for authentication. For example, the first keypoints or the first image may be more generic or may be available for use for a longer time. In additional or alternative examples, less precise locations associated with the transaction may require additional or stepped-up authentication be performed prior to completion of the transaction.

In block 630, processor 370 receives, via communication interface 358, a time frame associated with the transaction. The time frame associated with the transaction can be received from a remote device associated with the user prior to the transaction. In some embodiments, the time frame associated with the transaction can be a large time frame such as a day or a week. In additional or alternative embodiments, the time frame associated with the transaction can be a few minutes.

In block 635, processor 370 stores, in database 354, the first keypoints as the authentication password as well as the location associated with the transaction, and the time frame. In some embodiments, the first keypoints, the location associated with the transaction, and the time frame can all be stored in the database 354 as associated with an identifier for the user (e.g., a user account).

In block 640, processor 370 receives, via communication interface 358, an authentication request. This operation can be similar to the operations performed in block 540 of FIG. 5. In some embodiments, the authentication request can include additional information, for example, a current location and current time of the transaction.

In block 645, processor 370 receives, via communication interface 358, a current location. In some embodiments, the current location can received from a remote device associated with the user and can indicate a current location of the remote device. In additional or alternative embodiments, the current location can be received from a payment processor or a merchant terminal indicating a current location of a merchant associated with the transaction.

In block 650, processor 370 determines whether the current location is within a threshold distance of the location associated with the transaction. In some embodiments, the authentication server 350 can strictly enforce location limitations such that the transaction can only be authenticated if the current location is within the location associated with the transaction that is stored in the database 354. In additional or alternative embodiments, the transaction can be allowed if the current location is within a predetermined threshold distance of the location associated with the transaction that is stored in the database 354.

In some examples, based on the distance between the current location and the location associated with the transaction the authentication server 350 can require stepped-up authentication. For example, processor 370 can transmit, via communication interface 358, a request for a second video of the user mouthing the passphrase, biometrics, or an answer to a security question. The processor 370 can receive, via communication interface 358, a second video of the user mouthing the passphrase, biometrics, or an answer to a security question and compare the received information with information stored in the database 354.

In block 655, processor 370 determines a current time. In some embodiments, the processor 370 receives, via communication interface 358 a current time indicating a time that the transaction was initiated. In additional or alternative embodiments, the authentication server 350 can include a clock or be communicatively coupled to a clock for determining the current time.

In block 660, processor 370 determines whether the current time is within the time frame. In some embodiments, the first keypoints set as the authentication password are only valid within the time frame and the authentication server rejects the transaction in response to the current time being outside the time frame. In additional or alternative embodiments, the authentication server 350 can require stepped-up authentication if the current transaction is within a threshold time of the time frame.

In block 665, processor 370 receives, via communication interface 358, second encrypted keypoints associated with a second image of the portable object. In block 670, processor 370 decrypts the second encrypted keypoints to generate the second keypoints. In some embodiments, the second keypoints were encrypted using the same key and encryption technique as the first keypoints. In additional or alternative embodiments, the processor 370 determines a second key for decrypting the second encrypted keypoints.

In some embodiments, the first encrypted keypoints were stored in the database 354 and are decrypted during the transaction. The first encrypted keypoints and the second encrypted keypoints may be encrypted based on the location associated with the transaction or the time frame and may be decrypted by the processor 370 using an encryption key determined using the current location and current time.

In block 675, processor 370 determines whether the second keypoints match the first keypoints. This operation can be similar to the operations performed in block 560 of FIG. 5. In some embodiments, the threshold similarity can be based on a difference between the current location and the location associated with the transaction and the difference between the current time and the time frame associated with the transaction.

In block 680, processor 370 transmits, via communication interface 358, authorization to a payment processor to provide payment to a merchant. In some embodiments, the authorization can include personal information or payment information associated with the user that can be used by the payment processor to provide the payment to the merchant. In additional or alternative embodiments, the authentication server can include the payment processor.

In block 685, processor 370 transmits, via communication interface 358, confirmation of the authorization of the transaction to a remote user device. The confirmation can be certified such that the user can display the confirmation to the merchant in order to receive the goods or service associated with the transaction.

In some embodiments, processor 370 flags the first keypoints in the database 358 as used in response to authorizing the transaction. The processor 370 may avoid comparing future keypoints to keypoints flagged as used. This can cause authentication passwords using keypoints to be OTPs.

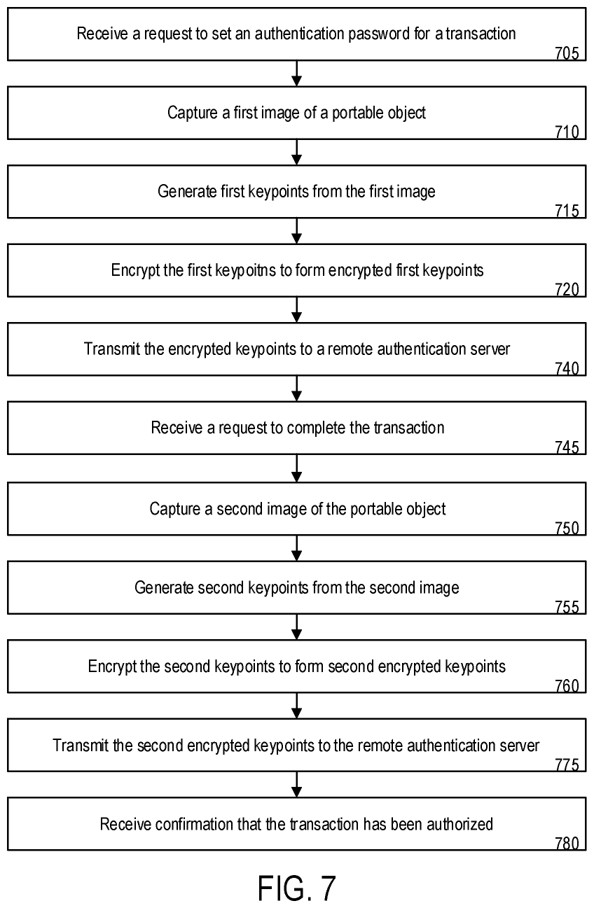

FIG. 7 depicts an example of a process for capturing and transmitting an image for use as a one-time password to an authentication server in accordance with some embodiments of the present disclosure. The process in FIG. 7 is described below in reference to user device 210 in FIG. 2, but other implementations are possible.

In block 705, processor 230 receives, via user interface 222, a request to set an authentication password for a transaction. The request can be received as part of an application running on the user device 210. For example, a banking application or a third-party authorization application may be accessed by a user via the user interface 222. In some embodiments, the operations described in FIG. 7 may be executed by the processor 230 as part of executing an application on the user device 210.

In block 710, processor 230 captures, via camera 212, a first image of a portable object. In some embodiments, the processor 230 verifies that the first image is live picture and an image of the portable object has not been used to set an authentication password within a set period of time.

In block 715, processor 230 generates first keypoints from the first image. In some embodiments, the first keypoints are generated by applying a SIFT algorithm to the first image. The first keypoints can be electronic identifiers of the first image or the portable object captured in the first image.

In block 720, processor 230 encrypts the first keypoints to form encrypted first keypoints. In some embodiments, the encryption key and encryption technique are received from an authentication server. In additional or alternative embodiments, the encryption key and encryption technique are determined based on an expected location or time frame that the transaction will occur.

In block 740, processor 230 transmits, via communication interface 224, the first encrypted keypoints to a remote authentication server. In other embodiments, the processor 230 transmits first keypoint or the first image to the remote authentication server.

In block 745, processor 230 receives a request to complete the transaction. In some embodiments, the request to complete the transaction is received from the user interface 222 as the user request funds be transferred from a user account to a merchant associated with the transaction. In additional or alternative embodiments, the request to complete the transaction is received from a payment processor or authentication server that were notified of the attempted transaction.

In block 750, processor 230 captures, via camera 212, a second image of the portable object. In block 755, processor 230 generates second keypoints from the second image. In block 760, processor 230 encrypts the second keypoints to form second encrypted keypoints. Operations in blocks 750, 755, 760, 775 can be similar to operations blocks 710, 715, 720, 725 however, the operations are performed during the transaction.

In some embodiments, processor 230 may receive a request for further authentication. For example, if the second keypoints fail to match the first keypoints the processor 230 may receive a request to capture another image of the portable object to and to transmit keypoints generated from the new image.

In block 780, processor 230 receives, via communication interface 224, confirmation that the transaction has been authorized. In some embodiments, the confirmation is received from the authentication server. In additional or alternative embodiments, the confirmation is received from a payment processor.

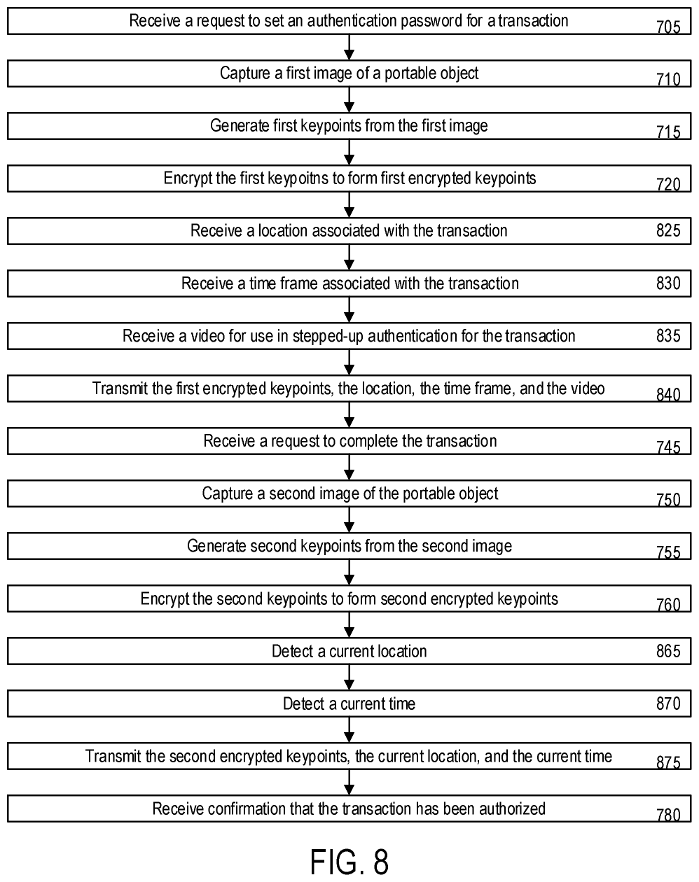

FIG. 8 depicts an example of another process for capturing and transmitting an image for use as a one-time password to an authentication server in accordance with some embodiments of the present disclosure. The process in FIG. 8 is described below in reference to user device 210 in FIG. 2, but other implementations are possible. Blocks 705, 710, 715, 720, 745, 750, 755, 760, 780 can be the same as in FIG. 7.

In block 705, processor 230 receives, via user interface 222, a request to set an authentication password for a transaction. In block 710, processor 230 captures, via camera 212, a first image of a portable object. In block 715, processor 230 generates first keypoints from the first image. In block 720, processor 230 encrypts the first keypoints to form encrypted first keypoints.

In block 825, processor 230 receives, via user interface 222, a location associated with the transaction. In some embodiments, the processor 230 displays, via the user interface 222, a map. In some examples, the processor 230 can detect a boundary drawn on the map and determine a location associated with the transaction based on the map. In additional or alternative examples, the processor 230 can detect specific merchant locations selected on the map. In additional or alternative embodiments, the processor 230 can receive, via user interface 222, geographic coordinates for the location associated with the transaction or information. In additional or alternative embodiments, processor 230 can receive, via user interface 222, information regarding a merchant and determine a location associated with the transaction based on the information regarding the merchant.

In block 830, processor 230 receives, via user interface 222, a time frame associated with the transaction. In some examples, the processor 230 receives a day or time in which the transaction is expected to occur.

In block 835, processor 230 receives, via camera 212, a video for use in stepped-up authentication for the transaction. In some embodiments, the camera 212 can capture a video of the mouth of the user mouthing a passphrase. The processor 230 may reject the video if it includes a threshold amount of sound or the video may be captured without sound such that the passphrase is non-verbal. The processor 230 may use the video for stepped-up authentication or may determine the passphrase from the video and use the passphrase as stepped-up authentication. In additional or alternative embodiments, processor 230 may receive additional information to be used as stepped-up authentication.

In block 840, processor 230 transmits, via communication interface 224, the encrypted keypoints, the location, the time frame, and the video. In some embodiments, the encrypted keypoints, the location, the time frame, and the video are transmitted to an authentication server that can store the information and use the information to authenticate the user during the transaction.

In block 745, processor 230 receives a request to complete the transaction. In block 750, processor 230 captures, via camera 212, a second image of the portable object. In block 755, processor 230 generates second keypoints from the second image. In block 760, processor 230 encrypts the second keypoints to form second encrypted keypoints.

In block 865, processor 230 detects a current location. In some embodiments, the current location is detected based on a global positioning system. In additional or alternative embodiments, the current location is detected based on a location of a wireless access point accessed by the user device 210. In some examples, the processor 230 can compare the current location to the location associated with the transaction and require stepped-up authentication in response to determining that the current location is a threshold distance from the location associated with the transaction.

In block 870, processor 230 detects a current time. In some examples, the processor 230 can compare the current time to the time frame associated with the transaction and require stepped-up authentication in response to determining the current time is outside of the time frame.

In block 875, processor 230 transmits, via communication interface 224, the second encrypted keypoints, the current location, and the current time. In some embodiments, the second encrypted keypoints, the current location, the current time are transmitted to an authentication server that can compare the information with previously provided information to authenticate the user during the transaction. In additional or alternative embodiments, processor 230 may provide additional information in response to receiving a request from the authentication server for stepped up authentication. For example, the processor 230 may capture a second video of the user mouthing the passphrase and transmit information associated with the second video to the authentication server.

In block 780, processor 230 receives, via communication interface 224, confirmation that the transaction has been authorized.

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented in entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A system comprising:
a database;
a communication interface;
a processing circuit; and
a memory having instructions stored therein that are executable by the processing circuit for causing the processing circuit to:
receive, via the communication interface, a request from a remote user device to set an authentication password for a transaction associated with a user of the remote user device, the request being received prior to the transaction;
receive, via the communication interface and prior to the transaction, first encrypted keypoints associated with a first image of a portable object;
decrypt the first encrypted keypoints to generate first keypoints;
store, in the database, the first keypoints as the authentication password and as associated with an identifier for the user;
receive, via the communication interface, an authentication request from the remote user device to use the authentication password to authenticate the user of the remote device to complete the transaction;
responsive to receiving the authentication request from the remote user device, causing the processing circuit to receive, via the communication interface, second encrypted keypoints associated with a second image of the portable object;
decrypt the second encrypted keypoints to generate second keypoints;
determine whether the second keypoints match the first keypoints; and
responsive to determining that the second keypoints match the first keypoints, causing the processing circuit to transmit, via the communication interface, authorization of the transaction.

2. The system of claim 1, wherein the memory has further instructions stored therein that are executable by the processing circuit for further causing the processing circuit to:
receive, via the communication interface and prior to the transaction, a location associated with the transaction;
store, in the database, the location as associated with an identifier for the user;
responsive to receiving the authentication request from the remote user device, causing the processing circuit to receive, via the communication interface, a current location of the remote user device; and
determine whether the current location is within a threshold distance of the location associated with the transaction.

3. The system of claim 2, wherein the memory has further instructions stored therein that are executable by the processing circuit for further causing the processing circuit to:
responsive to determining that the current location is more than the threshold distance from the location associated with the transaction, causing the processing circuit to transmit, via the communication interface, a request for stepped-up authentication to the remote user device; and
receive, via the communication interface, information associated with operation of the stepped-up authentication,
wherein causing the processing circuit to transmit authorization of the transaction comprises selectively causing the processing circuit to transmit authorization of the transaction in response receiving the information associated with operation of the stepped-up authentication.

4. The system of claim 3, wherein the memory has further instructions stored therein that are executable by the processing circuit for further causing the processing circuit to:
receive, via the communication interface from the remote user device and prior to the transaction, information associated with a first digital video of the user of the remote user device mouthing a passphrase; and
store, in the database, the information associated with the first digital video as associated with the identifier for the user,
wherein causing the processing circuit to receive information associated with the stepped-up authentication comprises causing the processing device to receive information associated with a second digital video of the user of the remote user device mouthing the passphrase,
wherein selectively causing the processing circuit to transmit authorization of the transaction further comprises selectively causing the processing circuit to transmit authorization of the transaction in response to determining whether the second digital video meets a threshold level of similarity with the first digital video.

5. The system of claim 1, wherein the memory has further instructions stored therein that are executable by the processing circuit for further causing the processing circuit to:
receive, via the communication interface from the remote user device and prior to the transaction, a time frame associated with the transaction,
wherein selectively causing the processing circuit to transmit authorization of the transaction comprises causing the processing circuit to verify that a current time of the transaction is within the time frame.

6. The system of claim 1, wherein the first keypoints are charactistic of the first image according to a scale-invariant feature transformation (“SIFT”) algorithm and the second keypoints are characteristic of the second image according to the SIFT algorithm,
wherein causing the processing circuit to determine whether the second keypoints match the first keypoints comprises causing the processing circuit to determine whether first keypoints and the second keypoints are associated with the same portable object using the SIFT algorithm.

7. The system of claim 1, wherein the authentication password is a one-time authentication password of a plurality of one-time authentication passwords for use at a merchant location, and the transaction is a point-of-sale transaction,
wherein causing the processing circuit to determine that the second keypoints match the first keypoints comprises causing the processing circuit to verify the first keypoints are unused,
wherein causing the processing circuit to transmit authorization of the point-of-sale transaction further comprises causing the processing circuit to:
transmit, via the communication interface, authorization to a payment processor to provide payment to a merchant associated with the transaction; and
transmit, via the communication interface, confirmation of authorization of the transaction to the remote user device,
wherein the memory has further instructions stored therein that are executable by the processing circuit for further causing the processing circuit to responsive to transmitting the authorization of the point-of-sale transaction, flagging the first keypoints as used.

8. The system of claim 1, wherein the memory has further instructions stored therein that are executable by the processing circuit for further causing the processing circuit to responsive to decrypting the first encrypted keypoints and prior to causing the processing circuit to store the first keypoints, verify the first keypoints do not match any keypoints stored in the database.

9. A method comprising:
receiving, via a communication interface, a request from a remote user device to form an authentication password for a transaction associated with a user of the remote user device, the request being received prior to the transaction;
obtaining, prior to the transaction, first keypoints comprising an electronic identification a first image of a portable object captured by the remote user device;
storing, in a database, the first keypoints as the authentication password and as associated with an identifier for the user;
receiving, via the communication interface, an authentication request from the remote user device to use the authentication password to authenticate the user of the remote device to complete the transaction;
responsive to receiving the authentication request from the remote user device, obtaining second keypoints comprising an electronic identification a second image of the portable object captured by the remote user device;
determining whether the second keypoints match the first keypoints; and
responsive to determining that the second keypoints match the first keypoints, transmitting, via the communication interface, authorization of the transaction.

10. The method of claim 9, wherein obtaining the first keypoints comprises:
receiving, via the communication interface, first encrypted keypoints associated with the first image of the portable object; and
decrypting the first encrypted keypoints to generate the first keypoints,
wherein obtaining the second keypoints comprises:
receiving, via the communication interface, second encrypted keypoints associated with the second image of the portable object; and
decrypting the second encrypted keypoints to generate the second keypoints.

11. The method of claim 9, wherein obtaining the first keypoints comprises:
receiving, via the communication interface, the first image of the portable object; and
generating first keypoints from the image,
wherein obtaining the second keypoints comprises:
receiving, via the communication interface, a second image of the portable object; and
generating first keypoints from the second image, the second keypoints.

12. The method of claim 9, further comprising:
receiving, via the communication interface from the remote user device and prior to the transaction, a location associated with the transaction;
receiving, via the communication interface from the remote user device and prior to the transaction, a time frame associated with the transaction;
storing, in the database, the location and the time frame as associated with the identifier for the user; and
responsive to receiving the authentication request from the remote user device, receiving, via the communication interface, a current location of the remote user device,
wherein transmitting the authorization of the transaction is in response to determining that the current location is within the threshold distance of the location associated with the transaction and determining that the current time is within the time frame.

13. A computer program product comprising non-transitory computer readable medium storing program code configured to be executed by a processing circuit to perform operations comprising:
receiving, via a user interface of a user device, a request to set an authentication password for a transaction at a remote location prior to the transaction;
responsive to receiving the request to set the authentication password for the future transaction at the remote location, capturing, via a camera, a first image of a portable object;
generating first keypoints from the first image, the first keypoints comprising an electronic identification of the first image;
encrypting the first keypoints to form first encrypted keypoints;
transmitting, via a communication interface, the first encrypted keypoints to a remote authentication server;
receiving, via the communication interface, a request to complete the transaction;
responsive to receiving the request to complete the transaction, capturing, via the camera, a second image of the portable object;
generating second keypoints from the second image;
encrypting the second keypoints to form second encrypted keypoints;
transmitting, via the communication interface, the second encrypted keypoints to the remote authentication server; and
receiving, via the communication interface, confirmation that the second keypoints matched the first keypoints and that the transaction has been authorized by the remote authentication server.

14. The computer program product of claim 13, wherein the operations further comprise:
receiving, via the user interface of the user device, a location associated with the remote location of the transaction prior to the transaction;
transmitting, via the communication interface of the user device, the location associated with the remote location of the transaction to the remote authentication server;
responsive to receiving the request to complete the transaction detecting a current location of the user device; and
transmitting, via the communication interface of the user device, the current location of the user device to the remote authentication server.

15. The computer program product of claim 14, wherein the current location is more than a threshold distance from the location associated with the remote location of the transaction, wherein the operations further comprise:
receiving, via the communication interface of the user device, a request for stepped-up authentication;
requesting, via the user interface of the user device, the stepped-up authentication from a user of the user device;
receiving, via the user interface of the user device, the stepped-up authentication from the user of the user device; and
transmitting, via the communication interface of the user device, information associated with the stepped-up authentication to the remote authentication server.

16. The computer program product of claim 15, wherein the operations further comprise:
capturing, via the user interface of the user device, a first digital video of a mouth of the user of the user device mouthing a passphrase;
transmitting, via the communication interface of the user device, information associated with the first digital video of the user of the user device mouthing the passphrase.
wherein receiving the stepped-up authentication from the user of the user device comprises capturing a second digital video of the mouth of the user of the user device mouthing the second passphrase,
wherein transmitting the information associated with the stepped-up authentication to the remote authentication server comprising transmitting information associated with the second digital video of the user of the user device mouthing the passphrase.

17. The computer program product of claim 13, wherein the operations further comprise:
receiving, via the user interface of the user device, a location associated with the remote location of the transaction prior to the transaction;
storing, by the user device, the location associated with the remote location of the transaction as associated with an identifier for a user of the user device;
responsive to receiving the request to complete the transaction detecting a current location of the user device; and
determining whether the current location of the user device is within a threshold distance from the location associated with the remote location of the transaction,
wherein capturing the second image of the portable object is further responsive to determining that the current location of the user device is within the threshold distance from the location associated with the remote location of the transaction.

18. The computer program product of claim 13, wherein the operations further comprise:
receiving, via the user interface of the user device, a time frame associated with the transaction prior to the transaction; and
transmitting, via the communication interface of the user device, the time frame associated with the transaction to the remote authentication server,
wherein receiving the confirmation that the second keypoints matched the first keypoints and that the transaction has been authorized by the remote authentication server further comprises receiving confirmation that the current time is within the time frame.

19. The computer program product of claim 13, wherein generating the first keypoints from the image comprises using a scale-invariant feature transformation (“SIFT”) algorithm on the image to produce the first keypoints,
wherein generating the second keypoints from the image comprises using the SIFT algorithm on the second image to produce the second keypoints.

20. The computer program product of claim 13, wherein the authentication password is a one-time authentication password of a plurality of one-time authentication passwords, the remote location is a merchant location, and the transaction is a point-of-sale transaction.
